(19) United States
(12) Patent Application Publication
(10) Pub. No.: US 2011/0175375 A1
(43) Pub. Date: Jul. 21, 2011

(54) Bottom pull rotary latch

(76) Inventors: David Lee Terhaar, Allegan, MI (US); David Jay Terhaar, Holland, MI (US)

(21) Appl. No.: 12/927,944

(22) Filed: Nov. 30, 2010

Related U.S. Application Data
(60) Provisional application No. 61/283,487, filed on Dec. 4, 2009.

(51) Int. Cl. E05B 65/12; E05C 3/12

(52) U.S. Cl. 292/220

(57) ABSTRACT

A rotary latch for selectively locking a closure, such as a tonneau cover, is provided with a bottom pull release lever. The pivot axis of the release lever is vertically offset relative to the pivot axis of a latch arm so that the latch arm extends in a first direction and the release lever extends generally transverse thereto in a second direction, and the latch arm engages the release lever at a middle portion thereof between the pivot axis and an actuator mount on the end of the release lever. The actuator mount is actuated by pulling substantially linearly in the first direction with minimal changes in the direction of the actuator force acting on the actuator mount.

### CROSS-REFERENCE TO RELATED APPLICATION

This application claims the benefit of U.S. Provisional Application No. 61/283,487, filed Dec. 4, 2009, the disclosure of which is hereby incorporated by reference in its entirety.

### FIELD OF THE INVENTION

The invention relates to a rotary latch for use with vehicle closures and more particularly, to a rotary latch with a pull point at the bottom of the latch.

### BACKGROUND OF THE INVENTION

Rotary latches are well known in the art, providing a strong, compact latching mechanism for many applications. A rotary latch generally includes a housing fixed to a first structure, such as a vehicle closure, having a U-shaped receiver which defines a slot or notch configured to receive a post fixed to an opposing structure, such as a vehicle body. A rotatable C-shaped latch is pivotally attached within the housing and arranged to rotate from a latched position, which is disposed within and perpendicular to the slot of the U-shaped receiver, to an unlatched position.

In the latched position, the C-shaped latch and the U-shaped slot overlap to define a central opening configured to hold the post wherein the C-shaped latch extends crosswise of the U-shaped slot with one leg of the C-shaped latch closing off the open end of the slot. In the unlatched position, the C-shaped latch is rotated outwardly toward the opening of the U-shaped slot, allowing the post to move into or out of the U-shaped slot as well as the mouth of the C-shaped latch. The C-shaped latch usually includes a catch on its body in an opposing position to the opening or mouth of the “C” relative to the pivot point of the latch. The catch is configured to act in concert with a trip lever pivotally mounted within the housing. The C-shaped latch and the trip lever are generally spring-biased by a common spring. The C-shaped latch is normally biased toward an open position and the trip lever is normally biased toward a locked position.

When the C-shaped latch is moved into the closed position which closes off the open end of the housing slot, the trip lever is biased to the locked position to engage the catch, thereby holding the C-shaped latch in the crosswise-oriented closed position. As such, while the slot has its open end closed by the C-shaped latch, the latch and slot are open on their opposite sides which allows the post to extend transversely through the open sides and be captured in the slot by the one leg of the C-shaped latch. This holds the closure in a closed, latched position.

The C-shaped latch is released by rotating the trip lever until it disengages from the catch. A stud is usually mounted to the trip lever for attachment of a release cable. Because of the configuration of the trip lever having a fixed pivot axle, it is necessary to arrange the release cable in a very narrow approach angle to the stud, in order to be able to pivot the trip lever with a minimal force exerted on and by the release cable.

Another known latch assembly is disclosed in U.S. patent application Ser. No. 11/650,736, which is owned by the common assignee of the present invention, and is published in US Publication No. 2007/0170728 A1, the disclosures of which are incorporated herein by reference in their entirety.

FIGS. 1-4 illustrate the latch disclosed in the '736 application and the environment in which same is used. In a motor vehicle 50, e.g. a pickup truck, a rotary latch is applied for latching a door on a pickup truck cap or, as here shown, a tonneau cover 55 over a pickup truck bed cargo area 60 having a truck bed wall 65 which typically comprises fixed side walls and an openable tail gate. The tonneau cover 55 is movable between an open position (shown) and a closed position (shown in phantom). In the closed position, the tonneau cover 55 can be secured by a rotary latch mechanism 100 releasably engaging a pin, or strike, 110 (FIG. 2). The latch mechanism 100 is here indicated as being mounted on the tonneau cover 55 and the pin 110 on the truck bed wall 65, respectively, but instead could be on the bed wall 65, such as the side walls or tail gate, and tonneau cover 55, respectively. The known latch mechanism 100 is attached to the inside of the tonneau cover 55 by a bracket 105. A cooperating pin or post 110 is mounted to the bed wall 65.

Referring further to FIGS. 3 and 3A, the known latch mechanism 100 includes a joystick 130. The joystick 130 is spring biased into a rest position (vertical as shown in the drawings), and displacement of the joystick 130 from such vertical position triggers unlatching of the latch mechanism 100 as seen in FIG. 3A.

The latch mechanism 100 is secured to the bracket 105 and to an alignment plate 195. In FIGS. 2 and 3, the bracket 105 is fixed to the tonneau cover 55 by bolt and nut units 194. The right end 196 of housing 140 defines a U-shaped channel-like slot, or notch, 198 for receiving the pin or post 110.

The latch mechanism 100 (FIG. 4) further includes a rotating latch member 200 and a rotating latch release member 205. The latch member 200 includes a C-shaped end portion 245 which extends across the slot 198 to capture the post 110 therein (FIG. 3). The joystick 130 has a base 305 which cooperates with a housing flange 316 and actuates the release member 205 when the joystick 130 is tilted, which thereby allows the latch member 200 to pivot open and release the post 110.

A given latch mechanism 100 may be used with one or more devices for unlatching same, such as a manually rotatable handle that pulls a drive cable connected to the latch mechanism 100, or a conventional power actuator (FIG. 4). As shown, the power actuator 115 is mounted in line with the latch mechanism 100 and fixed to the tonneau cover 55 by nut and bolt units 117. The power actuator 115 conventionally is electrically connected to a power source 120 (e.g. the vehicle battery) and operated by a switch 125. The switch 125 is conventionally capable of direct manual actuation or actuation by a conventional wireless remote control (not shown). The joystick 130 is connected to the power actuator 115 by a substantially rigid spring wire, push/pull connector, or “spring pull”, 135 (FIG. 4). Due to the construction of the joystick 130, displacement of the joystick 130 in any direction will actuate the latch mechanism 100. The power actuator 115 can be any type of mechanical or electrical actuator, or a hydraulic, magnetic, or pneumatic actuator. Furthermore, the actuator 115 need not be fixedly attached to the joystick 130, but need only be positioned so as to displace the joystick 130 upon activation.

In this rotary latch and other rotary latches, the joystick or other release member projects in the same direction as the open ends of the U-shaped housing slot and the C-shaped latch into which the post is received, or in other words, the release members would project in the direction of the receiving or latching side of the rotary latch. It may be said these rotary latches have such a receiving side, while the opposite side is the mounting side by which the rotary latch mounts to the closure or wall structure, such as by bracket 105. Hence, the release member projects away from the mounting side and away from the closure or wall structure with the free end of the release member extending away and spaced from such closure or wall structure.

Typically, however, the actuator is mounted directly to the closure such that a connector cable attaches to the release member at an acute angle relative to the tangential direction of the rotary release member, and at an acute angle relative to the mounting surface to which the rotary latch is mounted. In FIG. 4, the connector 135 has a length extending outwardly to the end of the joystick 135. As the release member rotates, the end of the release member moves closer to the mounting surface such that the attachment angle at least relative to the tangential direction increases. This thereby results in less efficient application of the actuator force since the vector component of this force acting on the release member is less efficiently applied.

It therefore is an object of the invention to provide a rotary latch that has in improved angle by which an actuator, such as a power actuator or manual actuator with cable, drives the rotary latch.

The invention relates to an improved rotary latch for selectively locking a closure, such as a tonneau cover on a pickup truck bed or the swing-up window on a pickup truck cap, which includes a rotating C-shaped latch member and a rotating release member which has an improved orientation relative to the latch member. The pivot axes of the latch member and release member are vertically offset so that the release member is oriented transverse to the latch member which extends in a first direction, and projects in a second direction downwardly or transversely to the first direction. In this direction, the pivot. axis of the release member is spaced away from the mounting side of the rotary latch, and the release member projects toward the mounting side rather than toward the receiving or latching side. This places an actuator mount on the end of the release member close to the mounting surface to which the rotary latch is mounted.

Further, the latch member engages the release member at an intermediate location between the pivot axis of the release member and the actuator mount at the outer end of the release member. The actuator pulling force thereby acts substantially tangential to the release member and substantially parallel to the mounting surface. The actuator mount is actuated by pulling substantially linearly in the first direction with minimal changes in the direction of the actuator force acting on the actuator mount as the release member rotates and disengages from the latch member. This provides a more compact rotary latch mechanism and improves the transmission of the actuator force on the actuator mount.

Additionally, two separate springs are provided in respective engagement with the release member and the latch member which bias the latch member to its open position, and the release member to its engagement position. The separate springs have variable and different spring characteristics so that, for example, a stronger or more forceful spring can be provided on the latch member to provide stronger engagement with the post, while a less forceful spring can be provided on the release member to make it easier to operate the release member.

Other objects and purposes of the invention, and variations thereof, will be apparent upon reading the following specification and inspecting the accompanying drawings.

### BRIEF DESCRIPTION OF THE DRAWINGS

FIG. 1 is a side view of a pickup truck with a tonneau cover and a known rotary latch with joystick.

FIG. 2 is a partially broken sectional view of the known rotary latch, mounted on FIG. 1 to pickup truck bed wall and tonneau cover, and substantially as taken on the line 2-2 of FIG. 3.

FIG. 3 is a front view of the rotary latch of FIG. 2.

FIG. 3A shows an unlatched position of the FIG. 3 apparatus.

FIG. 4 is a pictorial view of the rotary latch of FIG. 3 in combination with a power actuator.

FIG. 5 is a pictorial view of the rotary latch of the invention with a power actuator.

FIG. 6 is an elevational view of the rotary latch from a first side.

FIG. 7 is a pictorial view of the rotary latch from the first side.

FIG. 8 is a pictorial view from the opposite second side.

FIG. 9 is a second-side elevational view of the rotary latch.

FIG. 10 is a pictorial view illustrating a latch member engageable with a release arm.

FIG. 11 is a second-side pictorial view of the rotary latch and power actuator.

FIG. 12 is a first-side view pictorial view of the power actuator.

FIG. 13 is a second-side elevational view of the rotary latch.

FIG. 14 is a top view thereof.

FIG. 15 is a second-side pictorial view with one housing wall removed.

FIG. 16 is a second-side elevational view showing a modified housing wall with springs engaged thereon.

FIG. 17 is a first-side elevational view with one housing wall removed.

FIG. 18 illustrates the latch member and release member in an engaged orientation.

FIG. 19 illustrates a partially disengaged position.

FIG. 20 illustrates a fully disengaged position.

FIG. 21 illustrates the latch member pivoted to an open position and the release member returned to an initial engagement position.

Certain terminology will be used in the following description for convenience in reference only and will not be limiting. The words “up”, “down”, “right” and left” will designate directions in the drawings to which reference is made. The words “in” and “out” will refer to directions toward and away from, respectively, the geometric center of the device and designated parts thereof. The words “proximal” and “distal” will refer to the orientation of an element with respect to the device. Such terminology will include derivatives and words of similar import.

### DETAILED DESCRIPTION

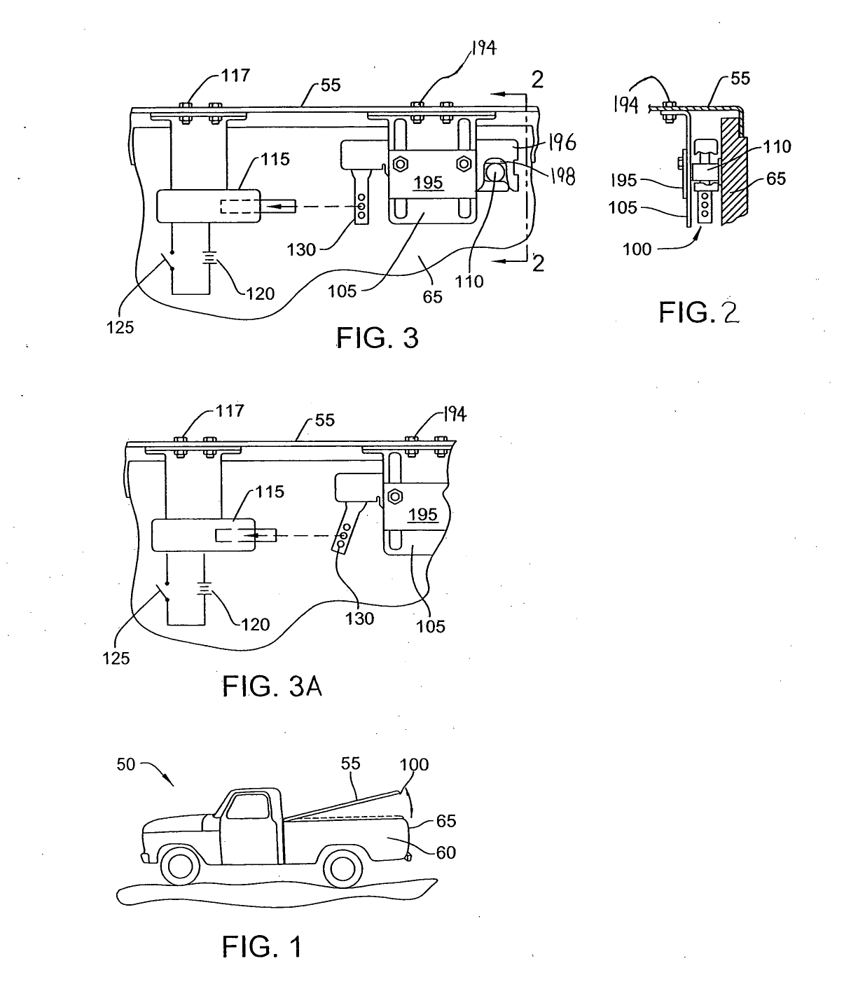

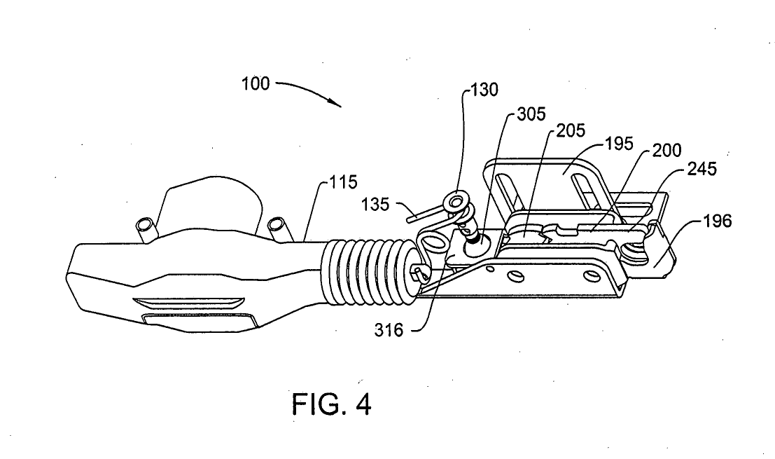

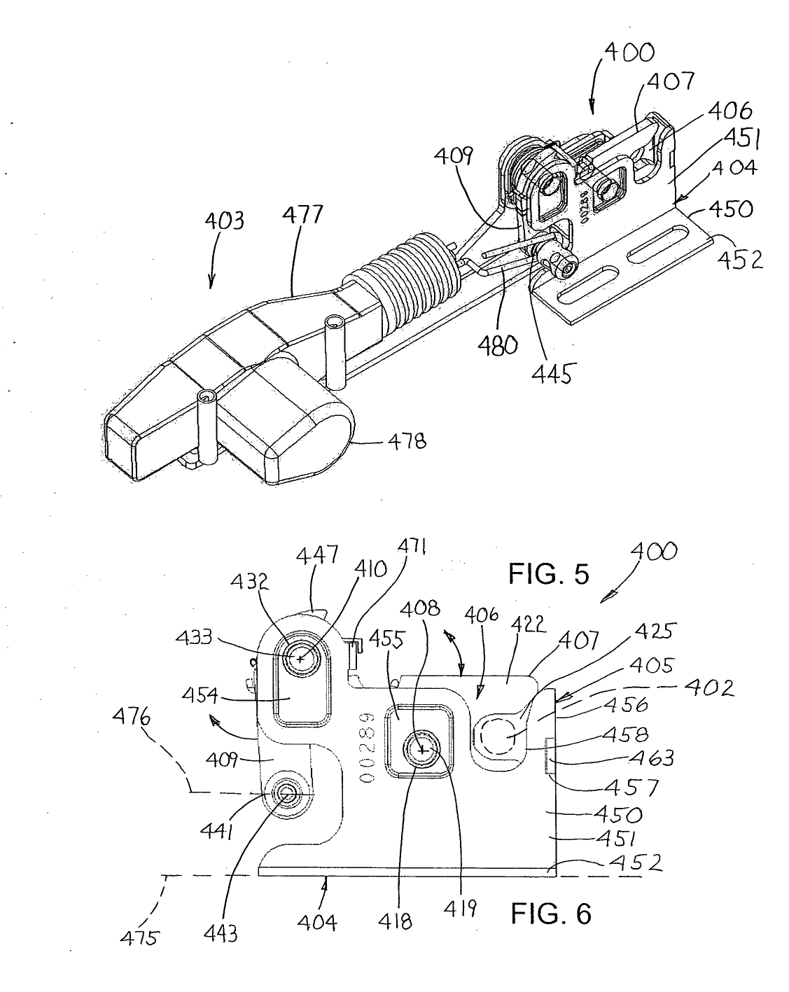

FIG. 1 shows an application by way of example and not limitation, for the present invention wherein the known latch 100 can be replaced with a rotary latch 400 of the invention. The invention relates to a rotary latch 400 (FIGS. 5-6) that is applicable in any enclosure requiring selective latching, and wherein the release of said latching can be accomplished by powered or manual actuation, electronically or mechanically, or by direct or remote control. In the motor vehicle 50, e.g. a pickup truck, the rotary latch 400 of the invention disclosed hereinafter is applied for latching the vehicle closure, such as a door on a pickup truck cap or, as here shown, the tonneau cover 55 over a pickup truck bed cargo area 60 having a truck bed wall 65 which comprises side walls and an openable tailgate. The tonneau cover 55 is movable between an open position (shown) and a closed position (shown in phantom). In the closed position, the tonneau cover 55 can be secured by the latch mechanism 400 of the invention releasably engaging a pin, post, or strike, 110 such as shown in FIG. 2 relative to the known latch mechanism or 402 as shown in FIG. 6 relative to the present invention.

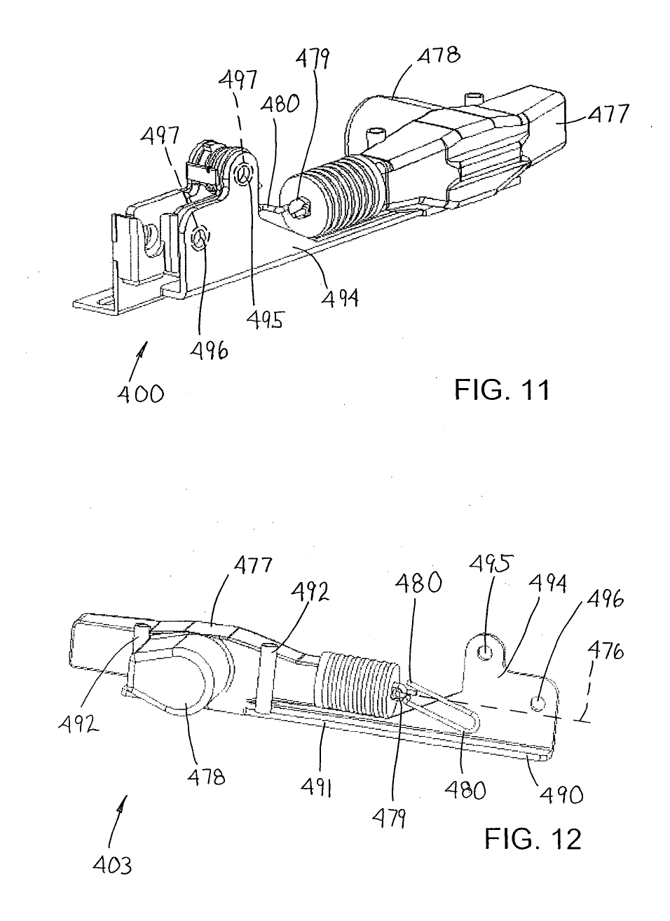

FIGS. 5-21 further illustrate the rotary latch 400. It will be understood the rotary latch 400 is readily mountable to the cover 55 and truck bed wall 65 or other closures and wall structures, and a detailed discussion is not required herein in view of the above discussion as to the latch 100 and the more detailed discussion provided in the afore-mentioned '728 application which was above-incorporated by reference.

Referring to FIG. 5, the rotary latch 400 may be operated by an actuator cable driven by a manual actuator or may be driven by a power actuator 403 which is drivingly connected to the rotary latch 400 and is operated like the power actuator 115 described above. The latch 400 generally includes a housing 404 which has a U-shaped end portion 405 that defines a post-receiving channel or slot 406. The slot 406 is configured to receive the post 402 therein as illustrated in phantom outline in FIG. 6.

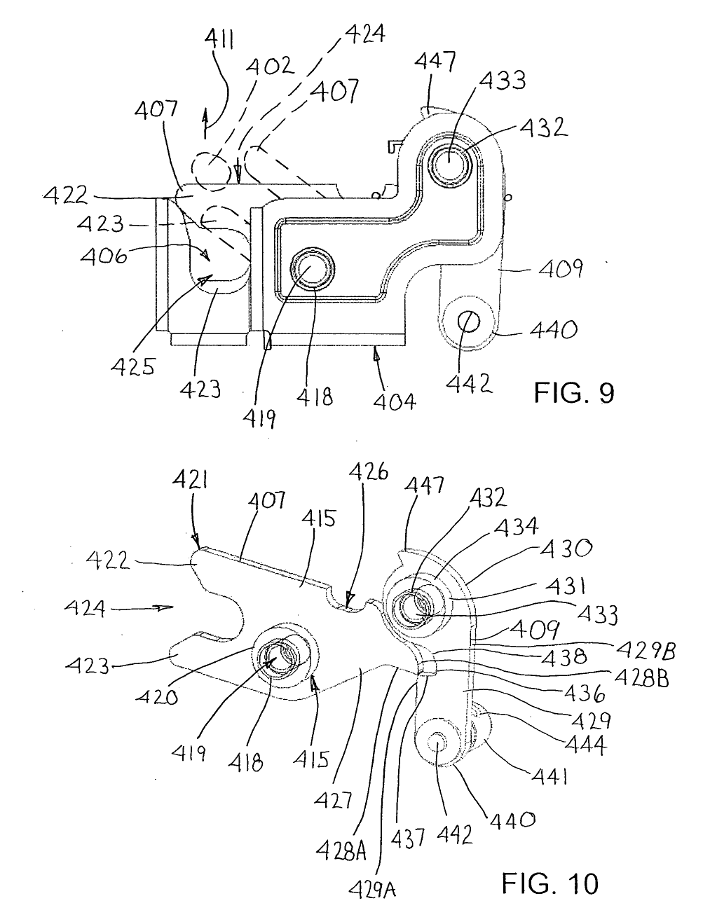

As seen in FIG. 6, the housing 404 pivotally supports a plate-like latch member or arm 407 for rotation about axis 408, and a release arm 409 for rotation about axis 410. As will be described further herein, the latch member 407 is rotatable between the latched position shown in FIG. 6 which captures the post 402 in the slot 406 and the upwardly-pivoted unlatched position shown in phantom outline in FIG. 9 wherein the post 402 is able to displace out of the slot 406 as indicated by reference arrow 411 (FIG. 9).

Referring to FIG. 10, the latch member 407 and the release arm 409 are shown separated from the housing 404 but positioned for engagement with each other. The latch member 407 has an elongate main body 415 which includes a rotation hub 416 configured to rotatably support the latch member 407 on the housing 404. The hub 416 comprises a thin-walled, cylindrical axle 418 which allows the main body 415 to freely rotate about the outer circumferential surface of the axle 418 and the axis 408 defined thereby (FIG. 6). The axle 418 projects from both sides of the main body 415 and has an internally-threaded bore 419 which extends coaxially through the axle 418 and opens from the opposite ends thereof. The axle 418 projects a greater distance on one side of the latch member 407 to support an annular spring bearing 420 fitted onto the axle 418.

The latch member 407 extends from the hub 416 to define a C-shaped end portion 421 defined by two laterally extending legs 422 and 423. The legs 422 and 423 are spaced apart to define a mouth or slot 424 which is open on one end to receive or release the post 402 when in the unlatched position shown in FIG. 9. When in the latched position of FIGS. 6 and 9, however, the legs 422 and 423 are configured to extend crosswise through the housing slot 406 wherein the outer leg 422 closes off the open end of the housing slot 406 to form an aperture 425 bounded by the upright edges of the slot 406 and the crosswise edges of the latch mouth 424, in which aperture 425 the post 402 is captured (FIG. 6). The aperture 425 is essentially open on the opposite sides to allow the post to project axially therethrough, but the post 402 is still captured in the aperture 425 when the latch member is rotated to the latched position.

The main body 415 also is formed with a notched spring seat 426 in the top edge thereof so that the latch member 407 is spring-biased to the unlatched position as will be described further herein.

The other end of the main body 415 narrows to define a laterally projecting nose 427 that defines a stop projection for engagement with the release arm 409 that releasably holds the latch member 407 in the latched position. The nose 427 has a flat stop surface 428A on one edge and an arcuate cam surface 429B on the opposite edge.

As to the release arm 409, this release arm member 409 serves to hold the latch member 407 in the latched position, but also is rotatable away from the latch member 407 to disengage from same and permit spring-biased rotation of the latch member 407 to the unlatched position for release of the post 402. As will be described hereinafter, the release arm 409 may be rotated by a manual actuator, such as a cable pulled by a manually-rotatable handle, or by the exemplary power actuator 403 (FIG. 5).

Referring to FIG. 10, the release arm 409 includes a main body 429 which has a hub end 430 that defines a rotation hub 431 formed substantially the same as rotation hub 416. As seen in FIG. 10, the latch member 407 and the release arm 409 are shown separated from the housing 404 but positioned for engagement with each other. The release arm 409 has the rotation hub 431 configured to rotatably support the release arm 409 on the housing 404. The hub 431 comprises a thin-walled, cylindrical axle 432 which allows the main body 429 to freely rotate about the axle 432 and the axis 410 defined thereby (FIG. 6). The axle 432 projects from both sides of the main body 429 and has an internally-threaded bore 433 which extends coaxially through the axle 432 and opens from the opposite ends thereof. The axle 432 projects a greater distance on one side of the release arm 409 to support an annular spring bearing 434 fitted onto the axle 432 for spring-biasing the release member 409 to the engagement position shown in FIG. 9 which holds the latch member 407 in the latched position, while permitting rightward rotation of the release arm 409 to release the latch member 407 which is then spring-biased to the unlatched position shown in phantom outline in FIG. 9.

To engage the latch member 407, the main arm body 429 has an intermediate section which is formed with a notched seat 436 on one body edge 429A for receiving the nose 427 of the latch member 407 therein. The seat 436 has a flat stop surface 437 and an arcuate interior edge 438 which is shaped to accommodate the nose 427. The opposite body edge 429B preferably is exposed laterally on one side of the housing 404 to allow outward pivoting or rotation of the release arm 409.

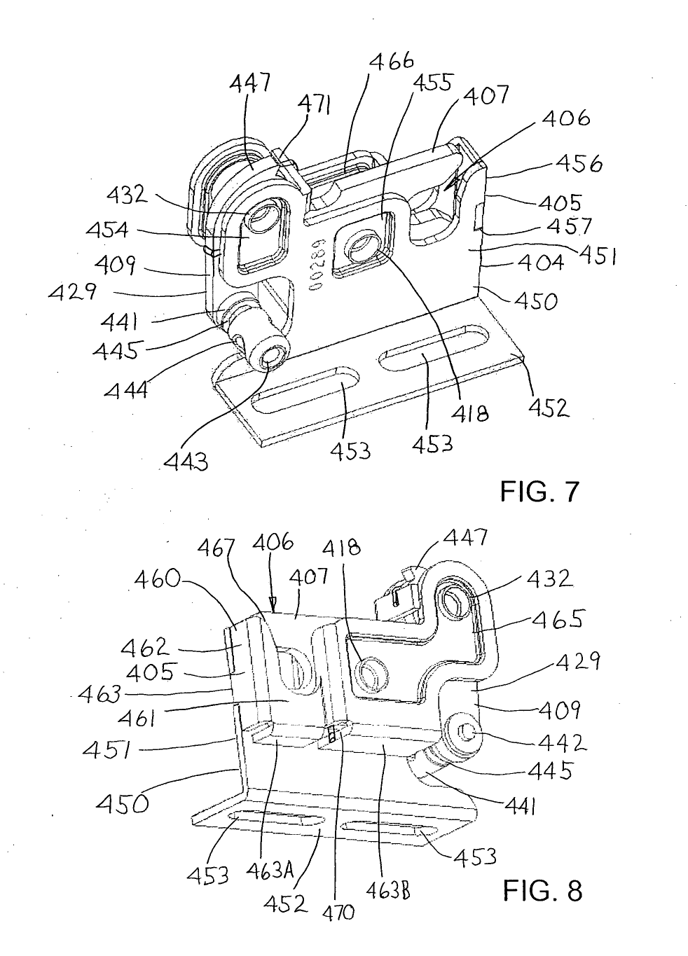

To rotate the release arm 409, the outer or free end 440 of the main body 429 has a sidewardly-projecting actuator mount 441 which is configured to connect to a manual or power actuator that pulls the outer arm end 440 rightwardly. As seen in FIG. 7, the mount 441 is connected to the main body 429 by a pivot pin 442 and is rotatable thereabout. The mount 441 is formed with an internally-threaded, blind end bore 443 extending axially, an open-ended transverse bore 444 extending diametrically, and an annular channel 445 extending circumferentially, which structures serve as connector structures for the connection to power actuators, manual actuators and any of their respective drive cables, connector clips or the like. The mount 441 thereby serves as the connection point or the pull point for the actuator, and the location at which an actuation force is applied to the release arm 409 to effect rotation thereof.

While the arm 409 is rotatable, the hub end includes a radially projecting limit stop 447 which faces circumferentially and defines the limit of rotation of the release arm 409 when actuated to the disengagement position.

In the latched position, the latch member 409 projects into and is oriented perpendicular to the slot 406 of the U-shaped end portion 405 which serves as a receiver for post 402. Generally, the latch member 409 and the slot 406 intersect to define the central opening or aperture 425. The rotary latch 400 is preferably mounted to the tonneau cover 55 and is aligned with and adapted to receive the post 402.

More particularly as to the housing 404 (FIGS. 6-8), this housing is configured for rotatably supporting the latch member 407 and the release arm 409 while also being mounted to the cover 55, and optionally being engaged with the power actuator 403. The housing 404 comprises a main housing wall or section 450 which preferably is formed in an L shape with two right-angle legs that define a wall plate 451 and a mounting plate 452. The mounting plate 452 includes fastener slots 453 therein that can allow for mounting to the cover 55 such as by the aforementioned fasteners 194 (FIG. 3) which project vertically through the fastener slots 453 and engage with fastener bores in the cover 55.

The wall plate 451 projects upwardly and in the preferred embodiment is formed with two stamped cavities 454 and 455 that respectively define holes that allow for the respective axles 432 and 418 to project therethrough. The axles 418 and 432 project through the wall openings and then are shaped, preferably by flaring the exposed end portions of the axles 418 and 432 to prevent removal through the wall openings. The latch member 407 and release arm 409 are still able to freely rotate about such axles 418 and 432.

Further, one wall edge 456 is provided with a locator notch 457. Proximate the edge 456, the wall plate 451 also includes an upper opening wall slot 458 which defines one side of the aforementioned post-receiving slot 406.

As to the opposite side of the housing 404, a second housing section 460 is provided which comprises a plate wall 461 and end wall 462 and bottom wall sections 463A and 463B as seen in FIG. 8. The end wall 462 includes a locator tab 463 that projects into the locator notch 457 of the opposite plate wall 451 to thereby locate, rigidify and assist in pre-assembly of the wall sections 450 and 460. Additionally, the bottom wall sections 463A and 463B project inwardly and abut against the inside face of the opposite wall plate 451.

The main wall plate 461 is provided with a stamped, recessed cavity 465 for strength and which also defines two circular openings therethrough to receive the outer ends of the latch axle 418 and release arm axle 432. These outer ends of the axles 418 and 432 project outwardly beyond the plate wall 465 and preferably are mechanically flared as described above relative to the opposite axle ends which are flared on the outer side of the wall plate 451. By flaring the cylindrical ends of the axles 418 and 432, the housing sections 461 and 450 are held together without requiring additional fasteners or welding, while at the same time, rotatably supporting the latch member 407 and the release arm 409 within the interior housing chamber 466 that is defined between the two housing sections 450 and 460 as seen in FIGS. 7, 8 and 14.

The end of the wall plate 461 also includes a wall slot 467 which is aligned with the opposite slot wall 458, which wall slots 467 and 458 essentially define the post slot 406 for receipt of the post 402 therethrough. These slots 458 and 467, however, are spaced apart so as to form the housing chamber 466 in which the latch member 407 is rotatably supported. Hence, the mouth 424 of the latch member 407 is disposed in the space between the two wall slots 458 and 467.

The housing 404 further defines spring stop surfaces. In this regard, the bottom housing wall sections 463A and 463B are spaced apart to define a spring-receiving channel 470. Additionally, the wall plate 451 has a transversely extending flange 471 which defines an additional spring stop as will be described further hereinafter. Essentially, the rotary latch 400 has a mounting or inner side which would be that side oriented inwardly when mounting to the cover 55. In the illustrated embodiment, the mounting side of the latch 400 would be that inner side on which the mounted plate 452 is disposed. This orients the slot 406 for receiving the post 402 such that the top or outer side of the latch 400 is the receiving side thereof. The mounting side does not require direct mounting to the vehicle structure but at least indicates the inner side opposite the outer receiving side.

Referring to FIG. 6, it is noted that the pivot axes 408 and 410 are not only sidewardly or laterally offset in a first direction, but also are offset upwardly or vertically in a second direction transverse to the first direction. As such, the release arm 409 extends downwardly or extends in the second direction away from the receiving or outer side and toward the mounting or inner side. As such, the actuator mount 441 is disposed closely proximate to a mounting or base surface 475, which mounting surface 475 could be the interior face of the tonneau cover 55 or possibly other similar structure to which the latch 400 is mounted. The surface 475 also could indicate a base or reference line extending along the inner edge of the latch 400. Since the actuator connects to the mount 441 and pulls the mount 441 to the left as generally indicated by reference line 476, the actuator generates a pulling force or actuator force which acts generally along line 476. Due to the orientation of the release arm 409, this actuator line 476 is disposed proximate to the mounting surface or reference line 475 and the pulling force applied to the mount 441 preferably is substantially parallel to the mounting surface 475.

One preferred actuator is the power actuator 403 illustrated in FIGS. 5, 11 and 12. The actuator 403 is a linear drive mechanism 477 preferably is driven by a drive motor 478. The drive mechanism 477 includes a retractable actuator member or rod 479 which is pulled linearly sidewardly when the motor 478 is powered. This actuator rod 479 has an eyelet at the end which connects to a connector clip 480, which clip 480 in turn clips into the groove 445 of mount 441. The linear movement of the actuator rod 479 is generally along the path 476 illustrated in FIG. 6 so that linear displacement of the actuator rod 479 essentially pulls the release arm 409 and its mount 441 sidewardly in the direction of line 476. Since the arm 409 rotates, there is some displacement of the arm upwardly relative to line 476 as seen in FIG. 20 as a result of the angular displacement 482 of the arm 409 (FIG. 20). The connector clip 480 provides a generally loose connection which causes pulling displacement of the arm mount 441, but also allows for some vertical displacement of the mount 441 as a result of the angular arm displacement 482. Since the arm 409 projects downwardly, and the mount 441 is normally disposed in alignment with the path 475 of actuator rod 479, the mount 441 and rod 479 are initially in alignment and the amount of vertical displacement of the mount 441 is greatly minimized. Preferably, the path or line 475 is close to or co-linear with the tangent of the release arm 409. This ensures that the pulling force or actuator force being applied to the mount 441 is most efficiently applied thereto. Further, this allows the power actuator 403 or even a cable extending along line 476 to be positioned close to the mounting surface 475 which minimizes the overall height of the latch 400 and any actuator connected thereto. Further, this minimizes the approach angle of any actuator connected to the mount 441 as it extends along line 476 and preferably is substantially if not exactly parallel to mounting surface 475.

To ensure proper positioning of latch 400 relative to the power actuator 403, the actuator 403 preferably includes a connector bracket 490 which has a bottom leg 491 that connects to two fastener posts 492 by which the power actuator 403 may be connected to the cover 55 or other suitable vehicle structure. The bracket 490 further includes a support flange 494 which projects upwardly and includes two fastener holes 495 and 496 which align with the bores 433 and 419 respectively in the rotary latch 400. Appropriate fasteners such as bolts 497 can then be inserted through the apertures 495 and 496 and threaded into the internally-threaded bores 419 and 433. In this manner, the latch 400 and actuator 403 may be pre-assembled together as a sub-assembly for subsequent mounting to the vehicle structure, such as the cover 55.

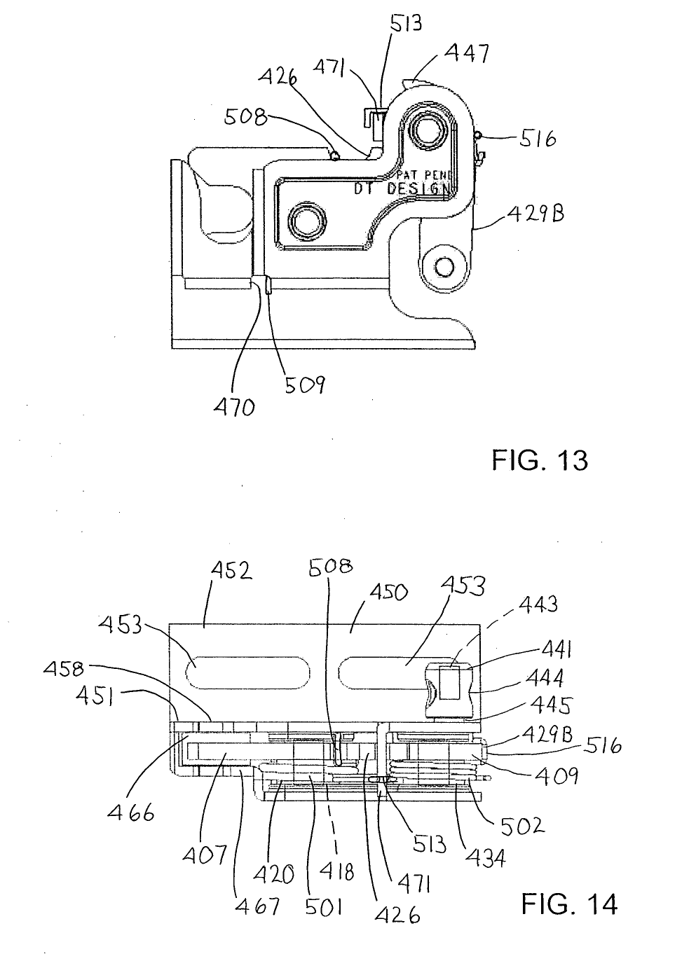

Next as to the biasing means, FIGS. 13, 14, 16 and 17 illustrate two separate coil springs 501 and 502 which respectively bias the latch member 407 and the release arm 409. While these biasing means are formed as coil springs 501 and 502, other biasing structures may be used such as leaf springs or the like to generate a biasing force on each of the latch 407 and release arm 409. Generally, the first spring 501 normally biases the latch member 407 from the latching position (FIG. 16) to the unlatching position (FIG. 17). This biasing force is indicated in FIG. 16 by reference arrow 505. The second biasing means, namely spring 502, normally biases the release arm 409 to the engagement position as indicated by reference arrow 506 while still permitting displacement of the release arm 409 to the disengaged position (FIG. 20).

Notably, the springs 501 and 502 are separate from each other and generate their own independent biasing forces such that the spring characteristics of the springs 501 and 502 may be made different to provide for the different respective biasing forces acting on the latch member 407 and release arm 409. Preferably, spring 501 is a heavier spring generating a greater latching force while spring 502 is a lighter spring which allows for easier movement of the release arm 409 but still is sufficient so as to maintain release arm 409 engaged with the latch 407 as shown in FIG. 16. For example, the biasing forces may set at a 4 to 1 ratio by suitable selection of the springs 501 and 502.

As to spring 501, the spring 501 includes a first spring leg 507 which includes a hook 508 on the end thereof that fits over and into the notch spring seat 426 and applies the spring force to the latch member 407. FIG. 16 illustrates the spring 501 with a second spring leg 509 which preferably is pulled circumferentially in the direction 510 to the seated position shown in phantom outline in FIG. 16. In this position, the spring leg seats within the housing slot 470 as seen in FIGS. 13 and 17. Hence, the latch member 407 is normally biased to the unlatched position of FIG. 17 but may be pivoted to the latched position of FIG. 16 due to resilient deflection of the spring 501.

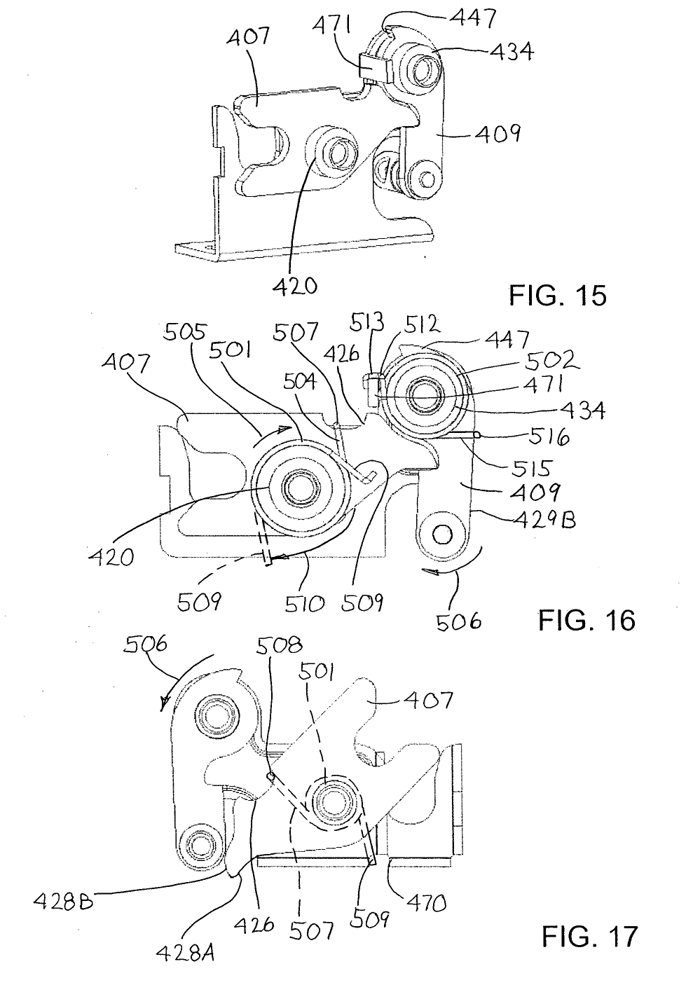

Spring 502 similarly has a first leg 512 with a hook 513 on the end thereof that engages or hooks over the spring flange 471 as seen in FIG. 15 and as illustrated in more detail in FIGS. 13, 14 and 16. A second spring leg 515 has a hooked end 516 which hooks over the outer edge 429B of the release arm 409 as seen in FIGS. 13, 14 and 16. This spring 502 therefore is disposed in tension and pulls the release arm 409 to the engagement position of FIG. 16 while also permitting rotation to the disengaged position of FIG. 20. These coil springs 501 and 502 respectively are supported on the spring hubs 420 and 434 as seen in FIGS. 14-16.

While the spring flange 471 (FIG. 15) supports the spring leg 512 thereon (FIG. 16), the flange 471 serves the additional function of defining a stop structure which is positioned to contact with the rotation stop 447 on the release arm 409. During outward rotation of the release arm 409, the stop 447 eventually will contact the upper edge of the stop flange 471 to stop outward displacement thereof.

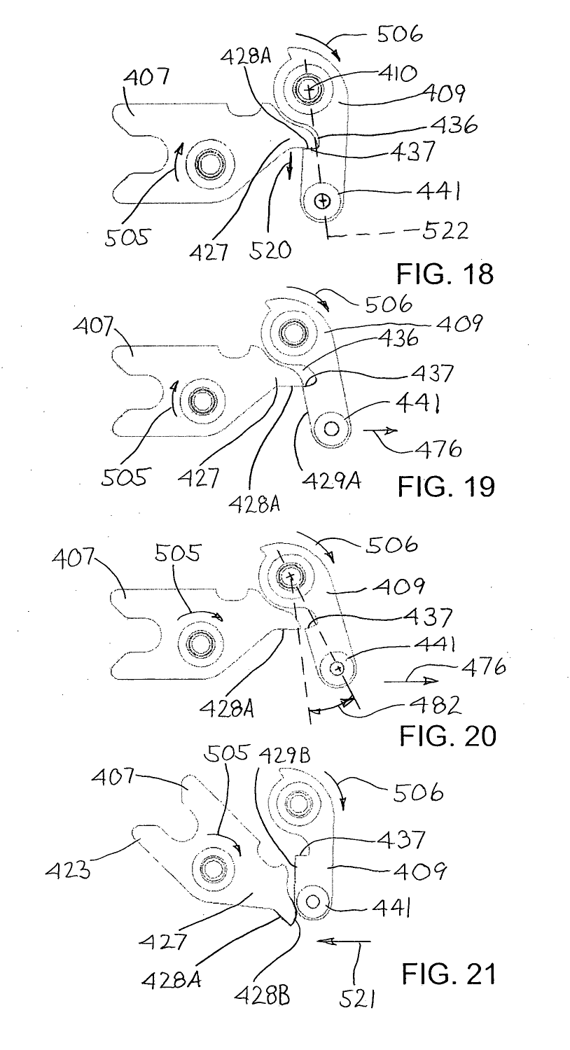

In operation, FIG. 18 illustrates the latch member 407 in the latched position with the release arm 409 in the engagement position. In this manner, the latch member nose 427 seats within the release arm notch 436 with stop surface 428A bearing downwardly on opposing notch surface 437 as indicated generally by reference arrow 520. This is the result of the biasing forces 505 and 506 acting on the rotatable structures. When an actuator pulls on the actuator mount 441 generally in the direction of actuator line 476, (FIG. 19) the nose 427 begins to disengage from the notch 436. Once the surfaces 428A and 437 clear each other, the latch member 407 is now able to rotate under the biasing force 505 until the lever arm 409 reaches its limit stop after the angular displacement indicated by arrow 482. This is the disengaged position of the release arm 409. Under this condition, FIG. 21 illustrates the latch member 407 rotated under the spring force 505 to the unlatched position also shown in phantom outline in FIG. 9.

The restoring force 506 acting on release arm 409 naturally pulls the actuator mount 441 back inwardly in the direction of arrow 521 (FIG. 21). In this position, it is noted that the arcuate surface 428B on the latch member nose 427 is in contact with the side edge 429B of the latch member 409. This arcuate surface 428B serves as a camming surface that slides along the release arm edge 429A and allows the latch member 407 to return to the latch position. These cooperating surfaces 428B and 429A slide along each other with the latch member nose 427 pushing or generating some limited rotary motion of the release arm 409 away from the engagement position which allows the nose 427 to slide upwardly until it seats back into the notch 436. FIG. 19 also illustrates the point at which the nose 427 clears the surface 429A and then is able to fall back into the notch 436 whereby the spring biased release arm 409 then rotates back to the engagement position of FIG. 18. Typically, this is accomplished merely by pushing the aforementioned post 402 downwardly into the slot 406 whereby the post 402 pushes on the bottom or inner latch member arm 423 (FIGS. 9 and 10), which thereby generates sufficient force to cause the reverse rotation of the latch member 407 form the unlatched orientation of FIG. 21 to the latched orientation of FIG. 18. In other words, as the cover 55 is closed, the latch 400 moves into engagement with the post 402 wherein closing of the cover 55 causes the post 402 to insert into the slot 406 which thereby pushes against the inner latch member arm 423 and rotates same to the latched condition.

FIG. 18 illustrates how the release arm 409 preferably has the rotation axis 410, the contacting notch surfaces 428A and 437, and the actuator mount 441 disposed along a common reference line 522 which is almost vertical or perpendicular to the mounting surface 475 (FIG. 6). The rotary latch 400 of the invention provides an improved orientation for the release arm 409 providing an improved structure and function.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A rotary latch mechanism mountable on a first structure for releasably latching to a post of a second structure comprising:
a housing having a post-receiving slot on an outer side which said slot opens outwardly from said outer side in a first direction, said housing having an inner side opposite said outer side;
a latch member pivotally mounted on said housing so as to be pivotable about a first pivot axis between a latching position and an unlatching position, said latch member extending sidewardly in a second direction transverse to said first direction, and having a latching portion and an engagement portion, said latching portion extending into said slot in said latching position and being pivoted out of said slot in said unlatching position, wherein said latch member is resiliently biased towards said unlatching position;
a release member pivotally mounted on said housing so as to be pivotable about a second pivot axis between an engagement position engaging said engagement portion of said latch member so as to hold said latch member in said latching position, and a disengagement position wherein said release member is separated from said engagement portion of said latch member, said latch release member being resiliently biased toward said engagement position, and said release member in said disengagement position being disengaged from said latch member which is released from said latching position and biased to said unlatching position, said first and second pivot axes being offset in spaced relation in both said first and second directions.

2. The rotary latch mechanism according to claim 1, wherein said release member extends in said second direction inwardly toward said inner side of said housing.

3. The rotary latch mechanism according to claim 2, wherein said release member has opposite inner and outer ends, wherein said outer end is pivotally mounted on said housing and said inner end is disposed inwardly of said outer end and is connected to an actuator which selectively effects rotation of said release member.

4. The rotary latch mechanism according to claim 3, wherein said engagement portion of said latch mechanism engages an intermediate section of said release member between said inner and outer ends.

5. A rotary latch mechanism mountable on a first structure for releasably latching to a post of a second structure comprising:
a housing having a post-receiving slot on an outer side which said slot opens outwardly from said outer side in a first direction, said housing having an inner side opposite said outer side;
a latch member pivotally mounted on said housing so as to be pivotable about a first pivot axis between a latching position and an unlatching position, said latch member extending sidewardly in a second direction transverse to said first direction, and having a latching portion and an engagement portion, said latching portion extending into said slot in said latching position and being pivoted out of said slot in said unlatching position, wherein said latch member is resiliently biased towards said unlatching position;
a release member pivotally mounted on said housing so as to be pivotable about a second pivot axis between an engagement position engaging said engagement portion of said latch member so as to hold said latch member in said latching position, and a disengagement position wherein said release member is separated from said engagement portion of said latch member, said latch release member being resiliently biased toward said engagement position, and said release member in said disengagement position being disengaged from said latch member which is released from said latching position and biased to said unlatching position, said release member having opposite inner and outer ends, wherein said outer end is pivotally mounted on said housing and said inner end is disposed inwardly of said outer end and is connected to an actuator which selectively effects rotation of said release member.

6. The rotary latch mechanism according to claim 5, wherein said release member extends in said second direction inwardly toward said inner side of said housing.

7. The rotary latch mechanism according to claim 6, wherein said engagement portion of said latch mechanism engages an intermediate section of said release member between said inner and outer ends.

8. A rotary latch mechanism mountable on a first structure for releasably latching to a post of a second structure comprising:
a housing having a post-receiving slot on an outer side which said slot opens outwardly from said outer side in a first direction, said housing having an inner side opposite said outer side;
a latch member pivotally mounted on said housing so as to be pivotable about a first pivot axis between a latching position and an unlatching position, said latch member extending sidewardly in a second direction transverse to said first direction, and having a latching portion and an engagement portion, said latching portion extending into said slot in said latching position and being pivoted out of said slot in said unlatching position, wherein said latch member is resiliently biased towards said unlatching position;
a release member pivotally mounted on said housing so as to be pivotable about a second pivot axis between an engagement position engaging said engagement portion of said latch member so as to hold said latch member in said latching position, and a disengagement position wherein said release member is separated from said engagement portion of said latch member, said latch release member being resiliently biased toward said engagement position, and said release member in said disengagement position being disengaged from said latch member which is released from said latching position and biased to said unlatching position; and
first and second biasing means being provided respectively in engagement with said latch member and said release member to normally effect biased rotation thereof, said first and second biasing members respectively defining first and second rotary biasing forces wherein said first and second biasing members are separated from each other to independently generate said first and second rotary biasing forces which are different from each other.

9. The rotary latch mechanism according to claim 8, wherein said release member extends in said second direction inwardly toward said inner side of said housing.

10. The rotary latch mechanism according to claim 8, wherein said first rotary biasing force is greater than said second rotary biasing force.

11. The rotary latch mechanism according to claim 8, wherein said first and second biasing members are defined by first and second spring members.

12. The rotary latch mechanism according to claim 11, wherein each of said first and second spring members has a first connector portion connected to said housing and a second connector portion connected to the respective one of the latch member and the release member to which the first and second spring members is connected.
